(19) United States
(12) Patent Application Publication
(10) Pub. No.: US 2026/0127836 A1
(43) Pub. Date: May 7, 2026

(54) SIMULATING HANGING OF VIRTUAL GARMENT

(71) Applicant: CLO Virtual Fashion Inc., Seoul (KR)

(72) Inventors: Tae Hyun KIM, Seoul (KR); Gimin NAM, Seoul (KR)

(21) Appl. No.: 19/373,756

(22) Filed: Oct. 30, 2025

(30) Foreign Application Priority Data
Aug. 5, 2025 (KR) 10-2025-0107629
Nov. 1, 2024 (KR) 10-2024-0153698

(51) Int. Cl. G06T 19/20; G06F 30/20

(52) U.S. Cl. CPC G06T 19/20; G06F 30/20; G06T 2210/16

(57) ABSTRACT

A method and apparatus for simulating hanging of a virtual garment are provided. The method includes obtaining a hanging mode of a hanger, arranging a target garment of the hanger based on the hanging mode with respect to a first feature area of the hanger, and hanging the target garment on the hanger by performing a simulation.

### CROSS-REFERENCES TO RELATED APPLICATIONS

This application claims the benefit of Korean Patent Application No. 10-2024-0153698, filed on November 1, 2024, and Korean Patent Application No. 10-2025-0107629, filed on August 5, 2025, in the Korean Intellectual Property Office, the entire disclosures of which are incorporated herein by reference for all purposes.

### BACKGROUND

### 1. Field of the Invention

One or more embodiments relate to a method and apparatus for simulating hanging of a virtual garment.

### 2. Description of the Related Art

A garment appears to be three-dimensional (3D) when worn on a person's body but is more two-dimensional (2D) because the garment is actually a combination of pieces of fabric cut according to a 2D pattern. In the fashion industry, computer-based clothing simulation technology is widely used to develop an actual clothes design. There is a growing demand for development of technology that simulates clothing in virtual environments to closely correspond to actual appearance, such as when designing a garment or simulating appearance of virtual characters wearing garments in the gaming industry.

### SUMMARY

According to an aspect, there is provided a method of simulating hanging of a virtual garment, the method including obtaining a hanging mode of a hanger, arranging a target garment of the hanger based on the hanging mode with respect to a first feature area of the hanger, and hanging the target garment on the hanger by performing a simulation.

The first feature area may include at least a portion of the hanger.

The at least a portion of the hanger may be determined based on the hanging mode.

The first feature area may include a shoulder area of the hanger, a clip area of the hanger, or an intersection area of the hanger.

The intersection area may include an area in which the shoulder area is connected to the clip area.

The first feature area may not include a hook area of the hanger.

The arranging of the target garment of the hanger based on the hanging mode with respect to the first feature area of the hanger may include arranging a second feature area of the target garment based on the hanging mode with respect to the first feature area of the hanger.

The second feature area may include at least a portion of the target garment.

A midpoint of the first feature area and a midpoint of the second feature area may be arranged to be aligned along a specific axis in a three-dimensional (3D) space in which the hanger and the target garment are arranged.

The second feature area may include a shoulder area of the target garment, a waist area of the target garment, or a neck area of the target garment.

A front direction vector of the target garment may be arranged parallel to a front direction vector of the hanger.

According to another aspect, there is provided an electronic device including at least one processor including processing circuitry and a memory configured to store instructions, wherein the instructions, when executed alone or jointly by the at least one processor, may cause the electronic device to obtain a hanging mode of a hanger, arrange a target garment of the hanger based on the hanging mode with respect to a first feature area of the hanger, and hang the target garment on the hanger by performing a simulation.

The first feature area may include at least a portion of the hanger.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1A is a flowchart illustrating a method of simulating hanging of a virtual garment, according to an embodiment;

FIG. 1B is a flowchart illustrating a method of simulating hanging of a virtual garment, according to an embodiment;

FIGS. 2A and 2B are diagrams illustrating a topology analysis of a hanger with a clip, according to an embodiment;

FIGS. 3A and 3B are diagrams illustrating a topology analysis of a hanger without a clip, according to an embodiment;

FIGS. 4A to 4C are diagrams illustrating simulation results of draping a garment on an avatar, according to an embodiment;

FIGS. 5A to 5C are diagrams illustrating extracting of feature points of a lower garment, according to an embodiment;

FIGS. 6A and 6B are diagrams illustrating simulation results of draping a garment on a hanger, according to an embodiment;

FIG. 7 is a diagram illustrating an auto-hanging simulation system according to an embodiment; and

FIG. 8 a diagram illustrating an example of a configuration of a device according to an embodiment.

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

With regard to the description of the drawings, similar reference numerals may be used to refer to similar or related components. It is to be understood that a singular form of a noun corresponding to an item may include one or more of the things, unless the relevant context clearly indicates otherwise.

As used herein, "A or B", "at least one of A and B", "at least one of A or B", "A, B or C", "at least one of A, B and C", and "at least one of A, B, or C," each of which may include any one of the items listed together in the corresponding one of the phrases, or all possible combinations thereof.

Terms such as "1st" and "2nd," or "first" and "second" may be used to simply distinguish a corresponding component from other components, and do not limit the components in other aspects (e.g., importance or order). For example, a first component may be referred to as a second component, and similarly the second component may also be referred to as the first component.

It is to be understood that if a component (e.g., a first component) is referred to, with or without the term "operatively" or "communicatively," as "coupled with," "coupled to," "connected with," or "connected to" another component (e.g., a second component), the component may be coupled with the other component directly (e.g., wiredly), wirelessly, or via a third component.

The singular forms "a", "an", and "the" are intended to include the plural forms as well, unless the context clearly indicates otherwise. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the embodiments are described in detail with reference to the accompanying drawings. When describing the embodiments with reference to the accompanying drawings, like reference numerals refer to like components, and any repeated description related thereto will be omitted.

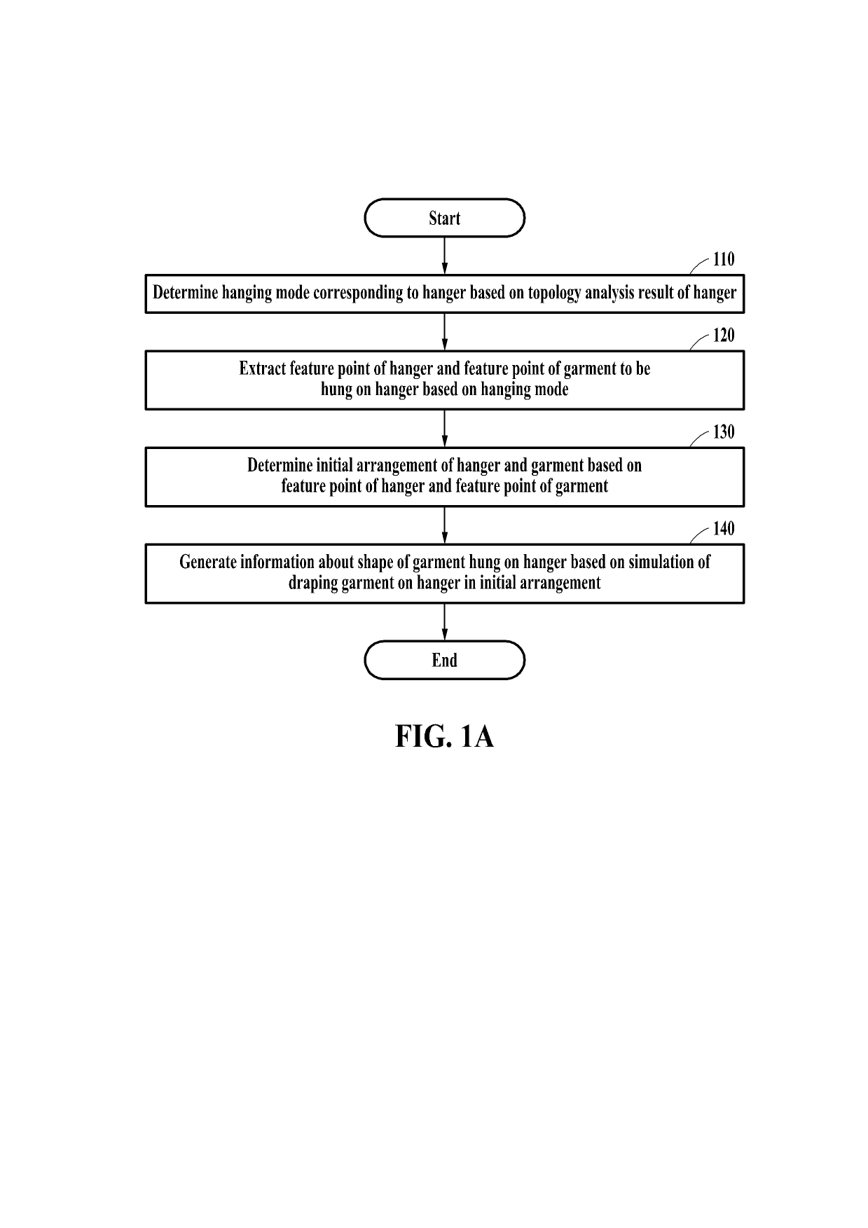

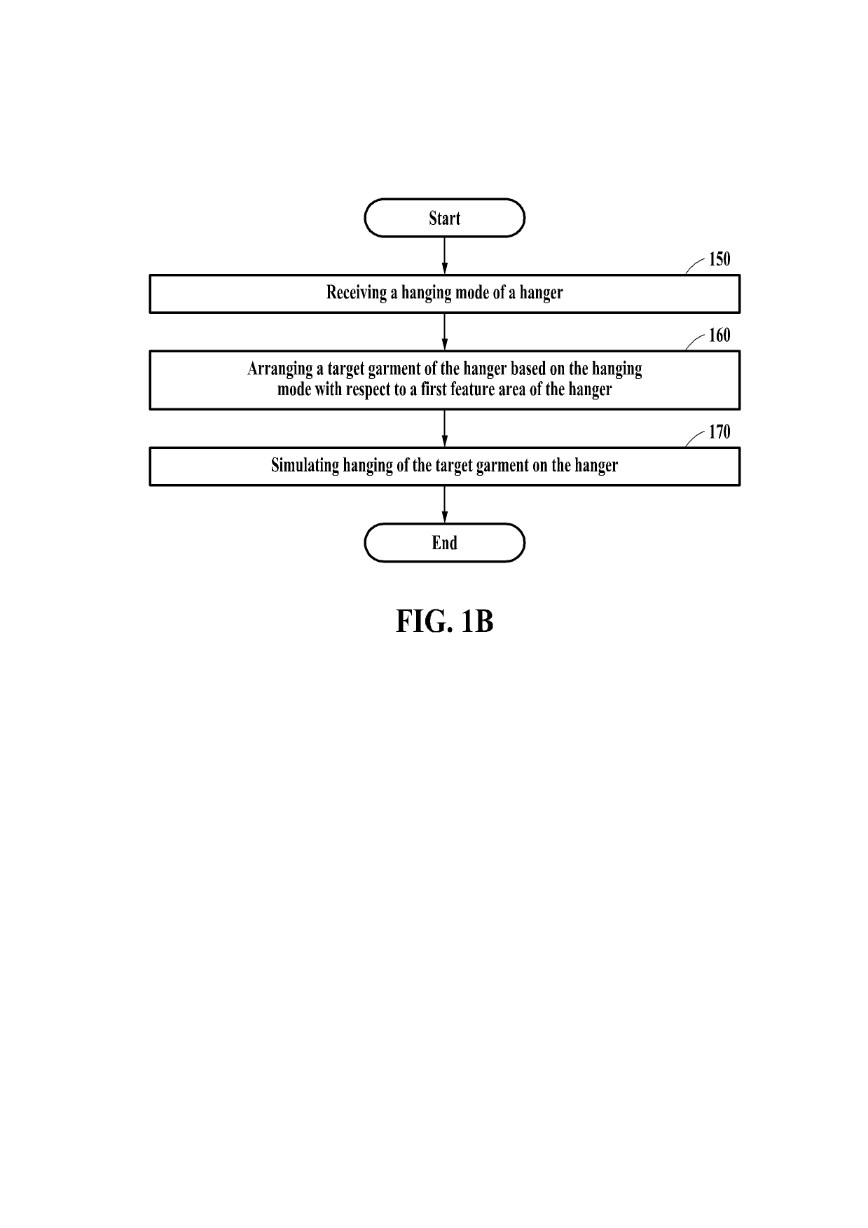

FIG. 1A is a flowchart illustrating a method of simulating hanging of a virtual garment, according to an embodiment.

Simulating hanging of a virtual garment may refer to automatically replicating a three-dimensional (3D) shape of a garment hung on a hanger in a virtual environment. In other words, the method of simulating hanging of a virtual garment may be a method of implementing a natural shape based on the laws of physics of a garment hung on a hanger.

The virtual garment may include a 3D modeled garment, and a surface of the garment may be defined as one or more meshes. The meshes may be in the form of polygons (e.g., triangles or squares) and may include a plurality of vertices and edges. A vertex corresponds to a point in a space of the surface, and an edge is a line segment connecting two different vertices.

Three or more vertices forming a polygon of the meshes may be points having mass (point mass), and each edge of the meshes may be represented as elastic springs connecting the mass. The virtual garment may be modeled, for example, by a mass-spring model. Here, the springs may have resistance values for stretch, shear, and bending, for example, depending on physical properties of fabric used. Each of the vertices may move according to actions of external forces, such as gravity, and internal forces, such as stretch, shear, and bending. By calculating the external and internal forces and determining the force applied to each vertex, displacement and movement velocity of each vertex may be determined. Furthermore, the movement of the virtual garment may be simulated through the movement of the vertices of the meshes at each point in time (time step). By draping the garment with the meshes onto a 3D avatar, a natural-looking 3D virtual garment may be implemented based on the laws of physics.

The method of simulating hanging of a virtual garment according to an embodiment may be performed by a processor of an electronic device. The specific hardware configuration of the electronic device is described in detail below.

Operations 110 to 140 included in the method of simulating hanging of a virtual garment, shown in FIG. 1A, may be performed sequentially but are not limited thereto. For example, the order of operations 110 to 140 may be changed, and at least two of operations 110 to 140 may be performed in parallel.

Hereinafter, the method of simulating hanging of a virtual garment may be referred to simply as "the method."

Referring to FIG. 1A, the method according to an embodiment may include operation 110 of determining a hanging mode corresponding to a hanger based on a topology analysis result of the hanger.

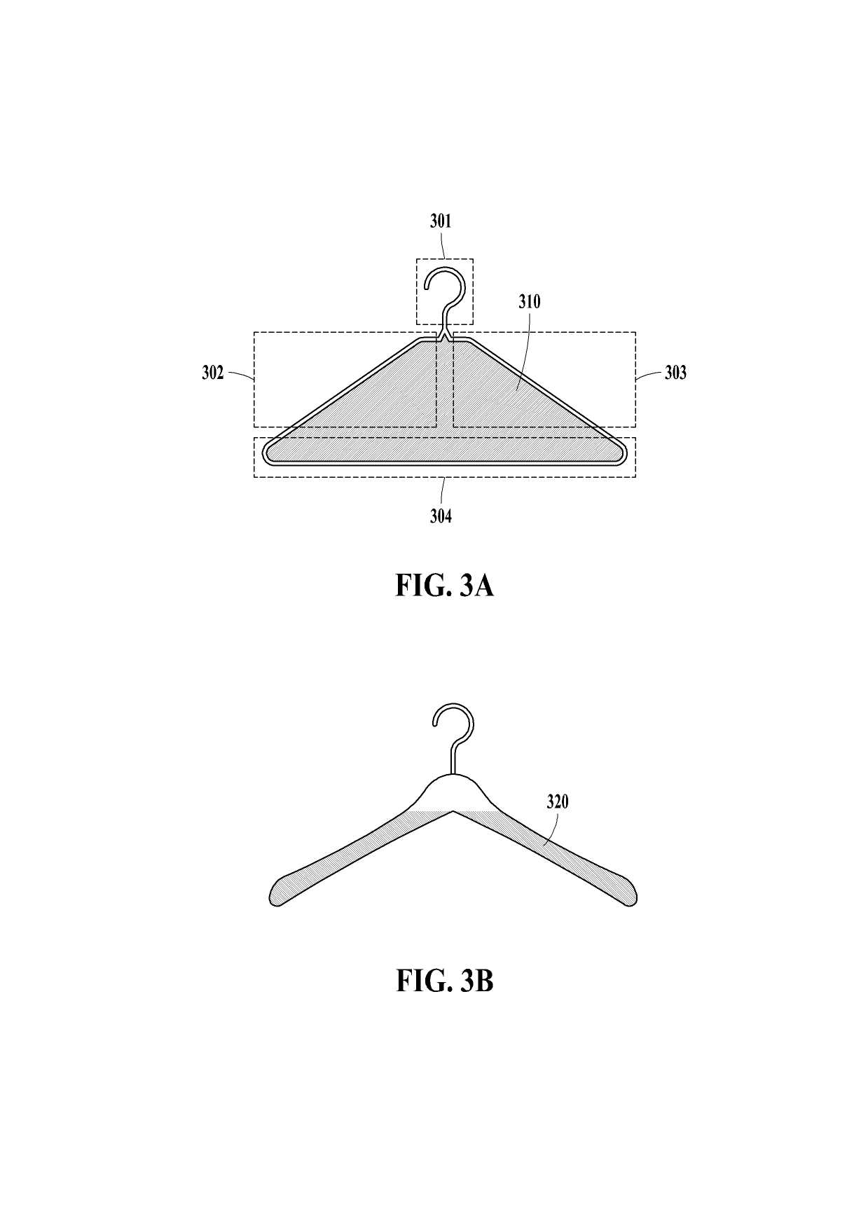

Referring to FIG. 3A, a hook portion 301 of the hanger for hanging the hanger on another object may be referred to as a hook. Portions 302 and 303 extending from the hook to both sides (e.g., left and right) may be referred to as shoulder areas of the hanger. A portion 304 connecting the two shoulder areas of the hanger may be referred to as a bottom bar. Hereinafter, the hanger is described assuming that the hook of the hanger is positioned upward and the bottom bar downward, as shown in FIG. 3A.

Referring again to FIG. 1A, the hanger may include hangers of various shapes and/or modes. Hereinafter, hangers having different shapes and/or types may be referred to as having different “modes”. For example, the hanger may include various modes of hangers, such as a hanger with a clip, a hanger without a clip, a hanger with a bottom bar, a hanger without a bottom bar, a hanger with both shoulder areas extending diagonally from a hook, a hanger with both shoulder areas extending horizontally, a hanger with both shoulder areas having a straight shape, and a hanger with both shoulder areas having a curved shape.

The hanger may include hangers in various shapes that belong to the same mode but have different shapes. For example, the hanger may be classified into a hanger with a clip and a hanger without a clip. When a first mode of the hanger is the hanger with the clip, the hanger may include a plurality of hangers of the first mode having different shapes of clips. When a second mode of the hanger is the hanger without the clip, the hanger may include a plurality of hangers of the second mode having closed curves with different sizes.

A topology analysis of the hanger may refer to analyzing properties of the shape of the hanger. For example, the hanger with the clip and the hanger without the clip may be determined to have different topologies, and as a result of the topology analysis, whether the hanger includes the clip may be determined. For example, a hanger with a closed curve and a hanger with an open curve may be determined to have different topologies, and as the result of the topology analysis, whether the hanger has the closed curve may be determined.

According to an embodiment, operation 110 of determining the hanging mode may include determining whether the hanger has a clip area based on the topology analysis result of the hanger and determining the hanging mode corresponding to the hanger based on whether the hanger has the clip area.

The hanging mode may be a classification of a mode of hanging a garment on the hanger. For example, the hanger with the clip and the hanger without the clip may be determined to have different hanging modes. For the hanger with the clip, the hanging mode may be determined as a mode of hanging the garment by grabbing the garment with the clip. For the hanger without the clip, the hanging mode may be determined as a mode of hanging the garment by draping a shoulder portion of the garment over the shoulder area of the hanger. For example, for a hanger having both the clip and the shoulder area, the hanging mode may be determined based on a user input.

The hanging mode may be determined based on the topology analysis result of the hanger. According to an embodiment, operation 110 of determining the hanging mode may include tracking an intersection of a plane and the hanger according to a position of a virtual plane and determining the hanging mode based on a result of the tracking of the intersection. Based on the result of the tracking of the intersection, whether the hanger has the clip may be determined. Based on the result of the tracking of the intersection, whether the hanger has the closed curve or the open curve may be determined. The method of analyzing topology of the hanger by tracking the intersection of the plane and the hanger according to the position of the virtual plane is described in detail below.

According to an embodiment, operation 110 of determining the hanging mode may include determining the hanging mode based on an object detection model. The object detection model may include a neural network trained to determine a topology mode of the hanger. The object detection model may determine that the hanger with the clip and the hanger without the clip have different topology modes. The object detection model may determine that the hanger with the open curve and the hanger with the closed curve have different topology modes.

According to an embodiment, the method may include operation 120 of extracting a feature point of the hanger and a feature point of the garment to be hung on the hanger based on the hanging mode.

The feature point of the hanger may be a vertex or a point that serves as a reference for hanging the garment on the hanger. For example, the feature point of the hanger may include at least one of a vertex that specifies a position where the shoulder of the garment hangs on the hanger and a vertex that specifies a position of the clip of the hanger. The feature point of the hanger may be extracted based on the topology analysis result of the hanger. The method of extracting the feature point of the hanger based on the topology analysis result of the hanger is described in detail below.

The feature point of the garment may be a vertex that serves as a reference for hanging the garment on the hanger. For example, the feature point of the garment may include at least one of a vertex that specifies the shoulder portion of the garment and a vertex that specifies a position where the garment is held by the clip. For example, the feature point of the garment may include a vertex that matches the feature point of the hanger.

The garment to be hung on the hanger may be determined based on the hanging mode. According to an embodiment, operation 120 of extracting the feature point of the hanger and the feature point of the garment to be hung on the hanger may include selecting the garment corresponding to the hanging mode and extracting the feature point of the hanger and the feature point of the selected garment based on the hanging mode.

For example, when the hanging mode is determined to be the mode of hanging the garment on the hanger by draping the shoulder portion of the garment, a garment with the shoulder portion may be determined as the garment corresponding to the hanging mode. Hereinafter, the hanging mode of hanging the garment on the hanger by draping the shoulder portion of the garment may be referred to as a first hanging mode. The garment with the shoulder portion may refer to a garment that includes a portion draped over the shoulder of a real person, a virtual avatar, or a character and may include, for example, at least one of an outer garment, a top, and a dress. The garment with the shoulder portion may be selected as the garment to be hung on the hanger corresponding to the first hanging mode. The garment with the shoulder portion may be referred to as an upper garment.

For example, when the hanging mode is determined to be the mode of hanging the garment by holding the garment by the clip, a garment including an area that may be held by the clip may be determined as the garment corresponding to the hanging mode. For example, when the hanging mode is determined to be the mode of hanging the garment by holding the garment by the clip, a garment without the shoulder portion may be determined as the garment corresponding to the hanging mode. Hereinafter, the hanging mode of hanging the garment by holding the garment by the clip may be referred to as a second hanging mode. The garment without the shoulder portion may refer to a garment that does not include a portion draped over the shoulder of a real person, a virtual avatar, or a character and may include, for example, lower garments such as pants or skirts. The garment without the shoulder portion may be selected as the garment to be hung on the hanger corresponding to the second hanging mode. The garment without the shoulder portion may be referred to as a lower garment.

According to an embodiment, operation 120 of extracting the feature point of the hanger and the feature point of the garment to be hung on the hanger may further include extracting the feature point of the garment based on a simulation result of draping the garment on an avatar. The simulation result of draping the garment on the avatar may include information about a position where the garment needs to be draped on the avatar. For example, based on the simulation result of draping the garment on the avatar, an area or vertex (vertices) of the garment draped at a shoulder position of the avatar may be extracted. For example, based on the simulation result of draping the garment on the avatar, an area or vertex (vertices) corresponding to a waistline of the garment draped at a waist position of the avatar may be extracted.

For example, the simulation result of draping the garment on the avatar may be data previously stored corresponding to the garment. In other words, the method according to an embodiment may include obtaining the simulation result of draping the garment on the avatar, which is stored corresponding to the garment. The simulation result of draping the garment may be a result of performing a simulation of draping the garment on the avatar and may include relationship information between the avatar and the garment.

For example, the simulation result of draping the garment on the avatar may be obtained by performing the simulation of draping the garment. In other words, the method according to an embodiment may include obtaining the simulation result of draping the garment by performing the simulation of draping the garment on the avatar.

According to an embodiment, operation 120 of extracting the feature point of the hanger and the feature point of the garment to be hung on the hanger may include, when the hanging mode is determined to be the first hanging mode, selecting the garment corresponding to the upper garment, extracting the feature point of the hanger corresponding to the shoulder position of the hanger based on the topology analysis result of the hanger, and extracting the feature point of the garment corresponding to the shoulder of the avatar based on the simulation result of draping the garment on the avatar. As described above, the upper garment may include not only general upper garments but also garments with shoulder portions, such as outerwear and dresses. When the hanging mode is determined to be the first hanging mode, the upper garment may be selected as the garment to be hung on the hanger.

Based on the topology analysis result of the hanger, the feature point of the hanger corresponding to the shoulder position of the hanger may be extracted. The feature point of the hanger corresponding to the shoulder position may correspond to a specific point (e.g., an end point) in the shoulder area of the hanger. The method of extracting the feature point of the hanger corresponding to the shoulder position based on the topology analysis result of the hanger is described in detail below.

Based on the simulation result of draping the garment on the avatar, the feature point corresponding to the shoulder of the avatar may be extracted from the garment. For example, based on the simulation result of draping the garment on the avatar, an area or vertex (vertices) in which the garment is draped at the shoulder position of the avatar may be extracted.

According to an embodiment, operation 120 of extracting the feature point of the hanger and the feature point of the garment to be hung on the hanger may include, when the hanging mode is determined to be the second hanging mode, selecting the garment corresponding to the lower garment, extracting the feature point of the hanger corresponding to a clip position on the hanger based on the topology analysis result of the hanger, and extracting the feature point of the garment corresponding to the waist of the avatar based on the simulation result of draping the garment on the avatar. As described above, the lower garment may include garments without shoulder portions, such as pants and skirts. When the hanging mode is determined to be the second hanging mode, the lower garment may be selected as the garment to be hung on the hanger.

Based on the topology analysis result of the hanger, the feature point of the hanger corresponding to the clip position of the hanger may be extracted. The feature point of the hanger corresponding to the clip position may correspond to a lower portion attached to the hanger. The method of extracting the feature point of the hanger corresponding to the clip position based on the topology analysis result of the hanger is described in detail below.

Based on the simulation result of draping the garment on the avatar, the feature point corresponding to the waistline of the garment draped at the waist or near to a position of the waist of the avatar may be extracted. For example, based on the simulation result of draping the garment on the avatar, an area or vertex (vertices) corresponding to the waistline of the garment may be extracted.

According to an embodiment, the extracting of the feature point of the garment corresponding to the waist of the avatar may include determining a set of vertices that is closest to the waist of the avatar among sets of vertices that are smoothly connected to each other within the garment and extracting a vertex corresponding to the clip position from the set of vertices. The method of extracting the feature point of the waistline of the garment based on the simulation result of draping the garment on the avatar is described in detail below.

According to an embodiment, operation 120 of extracting the feature point of the hanger and the feature point of the garment to be hung on the hanger may further include extracting the feature point of the garment based on a joint structure of the avatar. For example, arrangement information of at least some of the vertices of the garment and at least some of joints of the avatar may be obtained. For example, the arrangement information may include information indicating that a first vertex of the garment is arranged on a first joint of the avatar. By using the arrangement information, a vertex corresponding to a specific joint of the avatar may be extracted as the feature point of the garment.

According to an embodiment, operation 120 of extracting the feature point of the hanger and the feature point of the garment to be hung on the hanger may include determining the feature point of the garment based on attribute information that is pre-matched to the garment. The feature point may be extracted from the garment based on standardized attribute information of garments such as tops, outerwear, pants, skirts, and dresses. For example, when the garment is a top, both end points of a pattern indicating the shoulder portion of the garment may be extracted as the feature point.

According to an embodiment, operation 120 of extracting the feature point of the hanger and the feature point of the garment to be hung on the hanger may include determining the feature point of the garment based on the topology analysis result of the garment. Based on the topology analysis result, the shoulder or waistline of the garment may be determined, and a specific point on the shoulder or waistline may be extracted as the feature point of the garment.

According to an embodiment, operation 120 of extracting the feature point of the hanger and the feature point of the garment to be hung on the hanger may include determining the feature point of the garment using a learning model. The learning model may include a machine learning model trained to output the feature point of the garment when a 3D garment model or a two-dimensional (2D) garment pattern is input. The feature point of the garment may be obtained by applying the garment or the pattern of the garment to the learning model.

According to an embodiment, the method may include operation 130 of determining an initial arrangement of the hanger and the garment based on the feature point of the hanger and the feature point of the garment. The initial arrangement may refer to arrangement of the hanger and the garment in an initial state, which is before performing the simulation of draping the garment on the hanger.

According to an embodiment, operation 130 of determining the initial arrangement of the garment may include determining the initial arrangement of the hanger and the garment such that the feature point extracted from the garment is positioned at the feature point extracted from the hanger. For example, the initial arrangement of the hanger and the garment may be determined such that the feature point corresponding to the shoulder position of the garment is positioned at the feature point corresponding to the shoulder position of the hangers. For example, the initial arrangement of the hanger and the garment may be determined such that the feature point corresponding to the waistline of the garment is positioned at the feature point corresponding to the clip position of the hanger.

According to an embodiment, the method may include operation 140 of generating information about a shape of the garment hung on the hanger based on the simulation of draping the garment in the initial arrangement. The information about the shape of the garment hung on the hanger generated in operation 140 may include information for outputting the shape of the garment hung on the hanger. The information about the shape of the garment hung on the hanger generated in operation 140 may be obtained by executing the simulation of draping the garment on the hanger. As the result of the simulation of draping the garment, the information about the shape of the garment hung on the hanger, reflecting the laws of physics, may be obtained.

According to an embodiment, operation 140 of generating information about the shape of the garment hung on the hanger may include executing the simulation of draping the garment on the hanger by setting a position constraint on the feature point of the garment, which is a position where the garment is hung on the hanger, and generating the information about the shape of the garment hung on the hanger based on the result of the simulation of draping the garment on the hanger.

For example, by setting the position constraint on the feature point of the garment positioned at the clip portion of the hanger, information for outputting a clipped shape of a portion of the garment that is positioned at the clip portion, according to the laws of physics, may be generated.

FIG. 1B is a flowchart illustrating a method of simulating hanging of a virtual garment, according to an embodiment.

The method of simulating hanging of a virtual garment according to an embodiment may be performed by a processor of an electronic device. The specific hardware configuration of the electronic device is described in detail below.

Operations 150 to 170 included in the method of simulating hanging of a virtual garment described with reference to FIG. 1B may be performed sequentially but are not limited thereto. For example, the order of operations 150 to 170 may be changed, and at least two of operations 150 to 170 may be performed in parallel.

Hereinafter, the method of simulating hanging of a virtual garment may be simply referred to as the "method."

Referring to FIG. 1B, the method according to an embodiment may include operation 150 of obtaining a hanging mode of a hanger. The hanging mode of the hanger may be predefined corresponding each hanger. For example, information about the hanger may include information indicating the hanging mode of the hanger. The hanging mode of the hanger may be determined based on the user input. For example, the hanging mode of the hanger may be determined as a hanging mode specified by a user. As described above, the hanging mode of the hanger may be determined based on the topology analysis result of the hanger.

According to an embodiment, the method may include operation 160 of arranging a target garment of the hanger based on the hanging mode with respect to a first feature area of the hanger. The target garment of the hanger may refer to a garment to be hung on the hanger.

The first feature area may include at least a portion of the hanger. For example, the first feature area may include a shoulder area of the hanger, a clip area of the hanger, or an intersection area of the hanger. The intersection area may include an area where the shoulder area is connected to the clip area. The first feature area may not include a hook area of the hanger.

At least a portion of the hanger included in the first feature area may be determined based on the hanging mode. For example, when the hanging mode is the first hanging mode, the first feature area may be determined as the shoulder area of the hanger. For example, when the hanging mode is the second hanging mode, the first feature area may be determined as the clip area of the hanger. For example, the first feature area may correspond to a key area described above.

According to an embodiment, the arranging of the target garment of the hanger based on the hanging mode with respect to the first feature area of the hanger may include arranging a second feature area of the target garment with respect to the first feature area of the hanger based on the hanging mode.

The second feature area may include at least a portion of the target garment. For example, the second feature area may include a shoulder area of the target garment, a waist area of the target garment, a neck area of the target garment, when the target garment is a glove, a wrist area of the glove, or when the target garment is a sock, an ankle area of the sock. For example, the second feature area may correspond to the feature point extracted from the above-described garment. For example, the second feature area may correspond to an area including the feature point extracted from the above-described garment.

According to an embodiment, the first feature area and the second feature area may be arranged so as to be aligned along a specific axis (e.g., a z-axis or an axis of gravity) in a 3D space in which the target garment and the hanger are arranged. For example, a midpoint of the first feature area and a midpoint of the second feature area may be arranged so as to be aligned along the specific axis. For example, the midpoint of the first feature area may be a centroid, which is a geometric center point of the first feature area. For example, the midpoint of the second feature area may be a centroid, which is a geometric center point of the second feature area. For example, the first feature area and the second feature area may be arranged such that the first feature area and the second feature area are aligned along the specific axis and the distance between the midpoints of the first feature area and the second feature area is less than a threshold value.

According to an embodiment, a front direction vector of the target garment may be arranged parallel to a front direction vector of the hanger. In other words, a front direction of the target garment arranged based on the hanging mode may be configured to be parallel to a front direction of the hanger. In the 3D space where the target garment and the hanger are arranged, an orientation in which the target garment is arranged and an orientation in which the hanger is arranged may correspond to each other.

According to an embodiment, when the hanger is arranged in the 3D space, the initial arrangement of the hanger and the target garment based on the hanging mode may be determined based on the user input for arranging the target garment. For example, when the user input for determining the position of the target garment (e.g., an input for dragging the target garment) is received, a guide interface may be output based on the first feature area of the hanger, and the user may arrange the target garment on the hanger with reference to the guide interface. For example, the guide interface may indicate the position of the target garment in which the midpoint of the first feature area of the hanger and the midpoint of the second feature area of the target garment are aligned along the z-axis.

According to an embodiment, the target garment may be arranged based on the hanging mode with respect to the first feature area of the hanger by an input activating a hanging function.

The method according to an embodiment may include operation 170 of hanging the target garment on the hanger by performing a simulation. The simulation may include a simulation of draping the target garment on the hanger. As the result of the simulation, information about the shape of the target garment hung on the hanger, reflecting the laws of physics, may be obtained. As an example, operation 170 may include operation 140 of FIG. 1A.

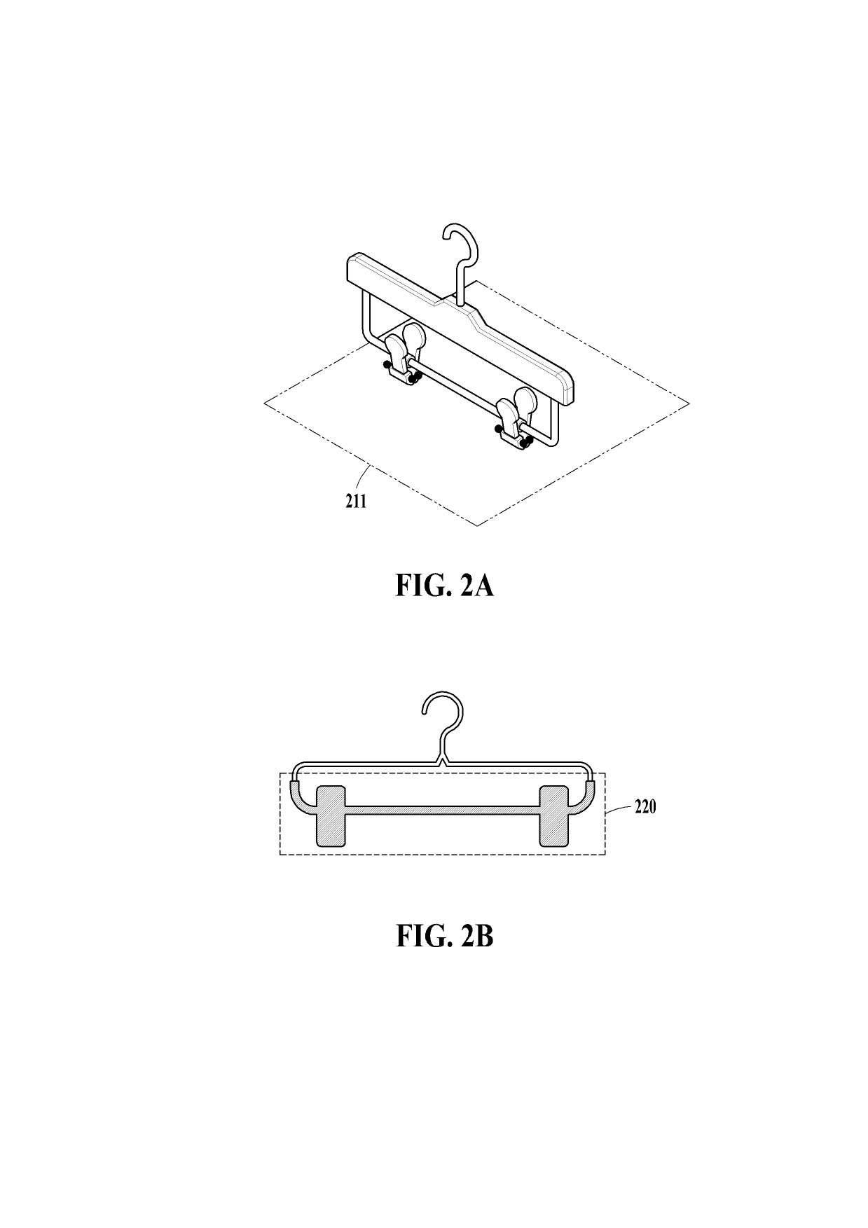

FIGS. 2A and 2B are diagrams illustrating a topology analysis of a hanger with a clip, according to an embodiment.

Referring to FIG. 2A, a virtual plane 211 may be generated in a virtual space where a hanger is placed. The hanger may be positioned horizontally in the virtual space, with a hook portion positioned at the top. By moving the virtual plane 211 upward from the bottom of the hanger, an intersection of the virtual plane 211 and the hanger may be tracked.

On the hanger, the clip may typically be hung on a bottom bar of the hanger or attached to a shoulder area of the hanger. A clamp area, which is a portion of the clip that holds a garment, may be positioned at the bottom of the hanger. Since the clamp area of the clip is positioned at the lowest point of the hanger, the intersection of the virtual plane 211 and the clamp area of the clip may be detected first. When the virtual plane 211 is positioned at the bottom of the hanger, the clamp portion of each of two clips of the hanger may intersect with the virtual plane 211, thereby generating an even number of intersection loops. For example, when clamp areas are tightly interlocked, two intersection loops may be detected, and when the clamp areas are separated, four intersection loops may be detected.

As the position of the virtual plane 211 moves upward, changes in the shape and number of intersection loops may be tracked. When the virtual plane 211 intersects with a clip area, the number of intersection loops may be maintained at two or more. Furthermore, when the virtual plane 211 intersects with a lower bar of the hanger, the intersection loops intersecting the clip area and intersection loops intersecting the lower bar may be detected.

When the position of the virtual plane 211 moves above the clip area, an intersection loop of a connection portion between the lower bar and the body of the hanger may be detected. When the position of the virtual plane 211 is positioned on a lower parallel line of the body of the hanger connected to the hook, one intersection loop may be detected. When one intersection loop is detected, a topology analysis of tracking the intersection loop by moving the position of the virtual plane 211 may be completed.

As a result of the topology analysis of the hanger using the virtual plane 211, the area from the bottom of the hanger to the point where one intersection loop is generated may be identified as a key area in which a garment is hung on the hanger.

For example, referring to FIG. 2B, an area 220 below a horizontal line segment of the shoulder area of the hanger may be determined as a key area. For example, in the case of the hanger including the clip, the number of intersection loops between the virtual plane and the hanger may be maintained at two or four, and then an intersection loop that intersects with a long parallel line segment (e.g., the bottom bar) may be generated. Therefore, as the result of tracking the intersection loop, when the number of intersection loops between the virtual plane and the hanger is maintained at two or four and then an intersection loop that intersects with the long parallel line segment (e.g., the bottom bar) is detected, the hanger may be determined to include the clip. A hanging mode corresponding to the hanger may be determined to be a second hanging mode.

As the result of tracking the intersection loops, when the hanging mode corresponding to the hanger is the second hanging mode, at least some vertices within the clamp area of the clip on the hanger may be determined as feature points of the hanger. For example, the clamp area of the clip on the hanger may be determined as an area that first intersects with the virtual plane. For example, the clamp area of the clip on the hanger may be determined as an area that first generates an even number of intersection loops with the virtual plane. At least some of the vertices included in the clamp area of the clip on the hanger, such as the center of the clamp area of the clip on the hanger and an arbitrary point, may be determined as the feature points of the hanger.

FIGS. 3A and 3B are diagrams illustrating a topology analysis of a hanger without a clip, according to an embodiment.

As described above, a virtual plane may be generated in a virtual space where the hanger is placed. The hanger may be positioned horizontally in the virtual space, with a hook portion positioned at the top. The virtual plane may move upward from the bottom of the hanger, and an intersection of the virtual plane and the hanger may be tracked.

Referring to FIGS. 3A and 3B, the hanger without the clip may or may not have a lower bar connecting to a shoulder area of the hanger.

As illustrated in FIG. 3A, when a horizontal lower bar exists, one intersection loop may be generated first, where the virtual plane intersects with the lower bar. When the virtual plane moves upward, two intersection loops intersecting with the shoulder area of the hanger may be generated. When the virtual plane moves further upward, the number of intersection loops may be reduced to one by intersecting with the hook or parallel portion of the hanger. When the number of intersection loops is reduced to one, the topology analysis of tracking the intersection loop by moving the virtual plane may be completed. As a result of the topology analysis of the hanger using the virtual plane, an area 310 from the bottom of the hanger to a point where one intersection loop is generated may be identified as a key area in which a garment is hung on the hanger.

As illustrated in FIG. 3B, when the lower bar does not exist, two or more intersection loops may be generated first, where the shoulder area of the hanger intersects with the virtual plane. As the virtual plane moves upward, the number of intersection loops may be reduced to one by intersecting with the hook or shoulder area of the hanger. When the number of intersection loops is reduced to one, the topology analysis of tracking the intersection loop by moving the virtual plane may be completed. As the result of the topology analysis of the hanger using the virtual plane, an area 320 from the bottom of the hanger to a point where one intersection loop is generated may be identified as the key area in which the garment is hung on the hanger.

Referring to FIGS. 3A and 3B, in the case of the hanger without the clip, it may be identified that the change in the number of intersection loops is less compared to the topology analysis result of the hanger with the clip. Furthermore, it may be identified that a gap between a plurality of intersection loops generated narrows as the virtual plane moves upward. Therefore, as the result of tracking the intersection loops, when the number of intersection loops between the virtual plane and the hanger is maintained at two (or more), and when the intersection loops are detected in the form in which the gap between the intersection loops narrows, the hanger may be determined to be without the clip. The hanging mode corresponding to the hanger may be determined as the first hanging mode.

As the result of tracking the intersection loops, when the hanging mode corresponding to the hanger is determined to be the first hanging mode, at least some of vertices within the shoulder area of the hanger may be determined as feature points of the hanger. For example, the shoulder area of the hanger may be determined as an area in which the gap between the intersection loops generated by intersecting with the virtual plane narrows as the virtual plane moves upward. At least some of the vertices within the shoulder area of the hanger, such as two end points of the shoulder area of the hanger or an arbitrary point, may be determined as the feature points of the hanger.

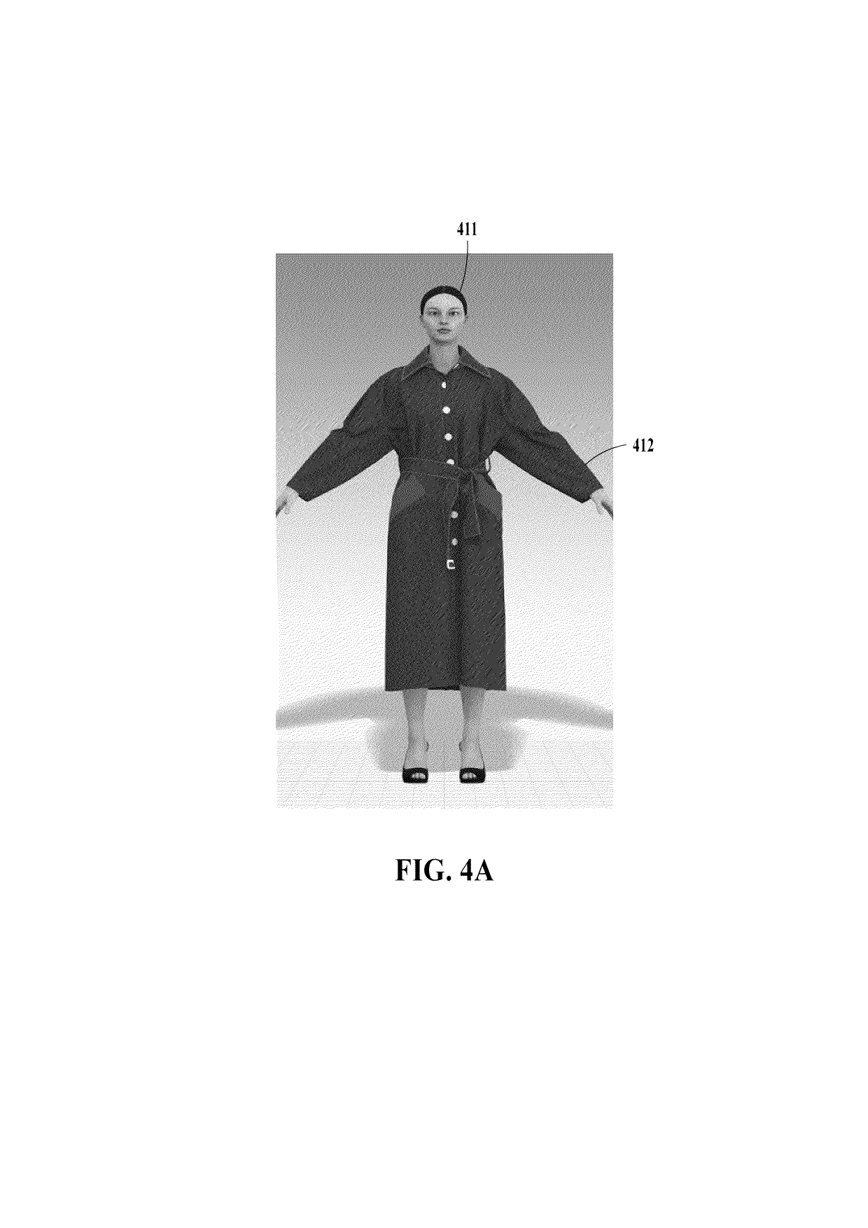

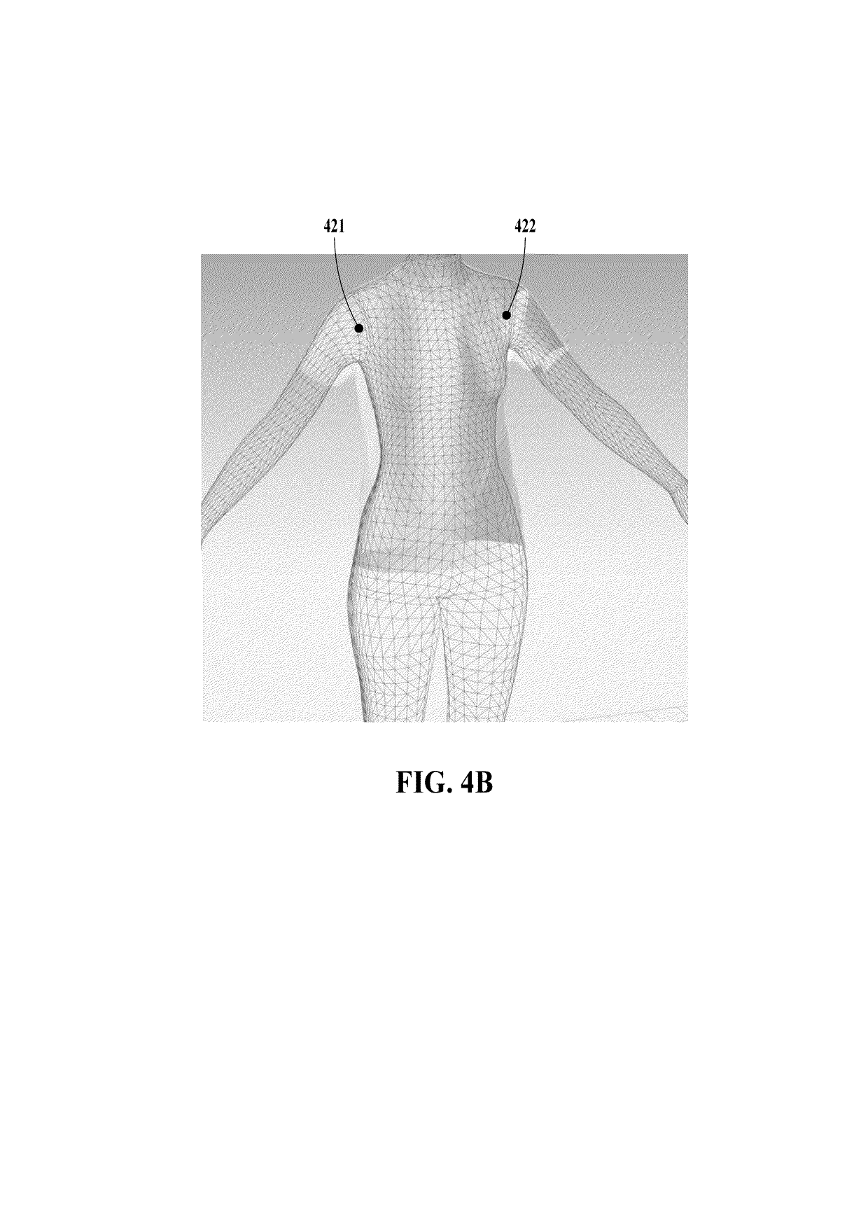

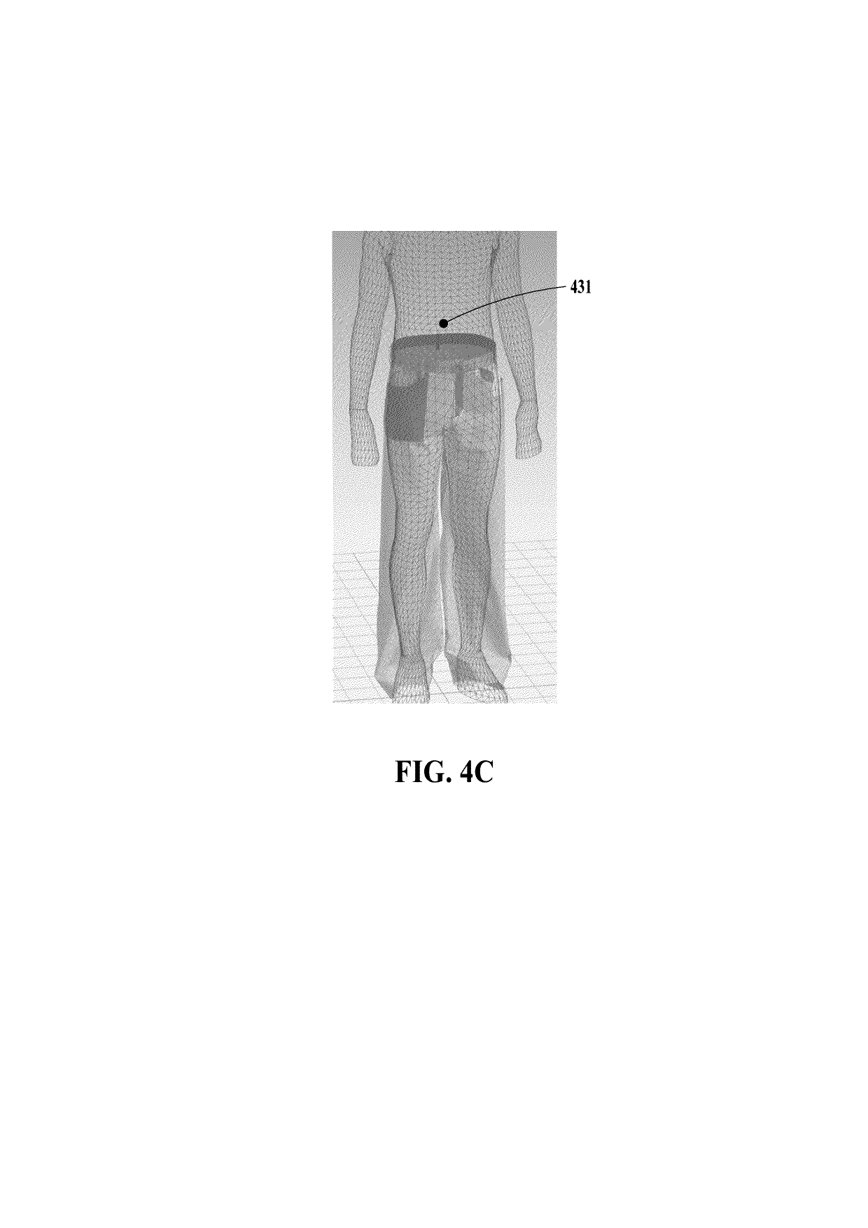

FIGS. 4A to 4C are diagrams illustrating simulation results of draping a garment on an avatar, according to an embodiment.

Referring to FIG. 4A, as a result of performing a simulation of draping a garment 412 on an avatar 411, an image of the garment 412 draped on the avatar 411 may be output. The simulation result of draping the garment 412 on the avatar 411 may include arrangement information about the garment 412 and the avatar 411. For example, the simulation result of draping the garment 412 on the avatar 411 may include information indicating where each vertex of the garment 412 needs to be arranged on the avatar 411. The simulation result of draping the garment 412 on the avatar 411 may be stored in correspondence with the garment 412.

Referring to FIG. 4B, feature points of a garment may be extracted based on the simulation result of draping an upper garment on an avatar. For example, vertices of the garment positioned on vertices 421 and 422 within the shoulder of the avatar may be extracted as the feature points of the garment. The feature points of the garment may be arranged on the feature points of the hanger corresponding to the first hanging mode.

Referring to FIG. 4C, feature points of a garment may be extracted based on the simulation result of draping a lower garment on an avatar. For example, the feature points of the garment may be extracted based on a vertex 431 indicating a position of the waist of the avatar. A specific method of extracting the feature points from the lower garment based on the simulation result of draping the garment on the avatar is described in detail below.

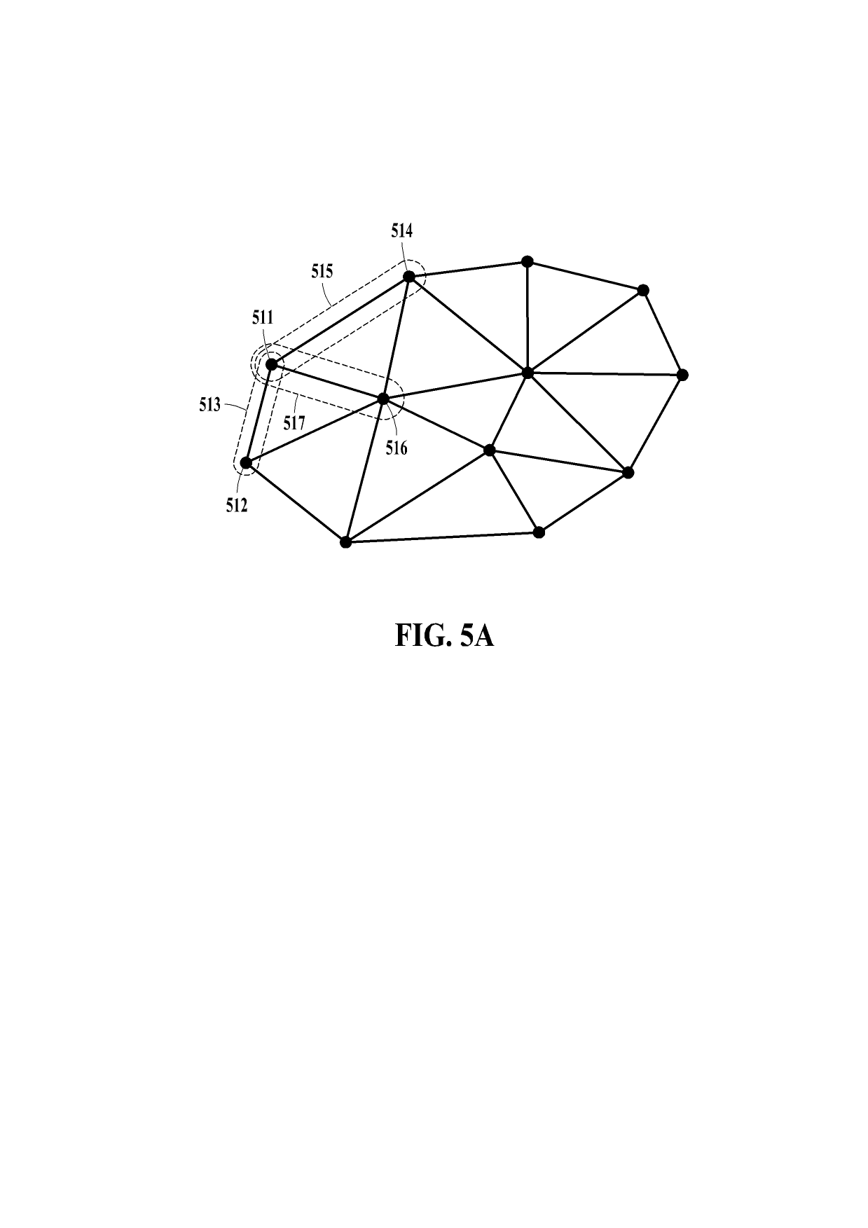

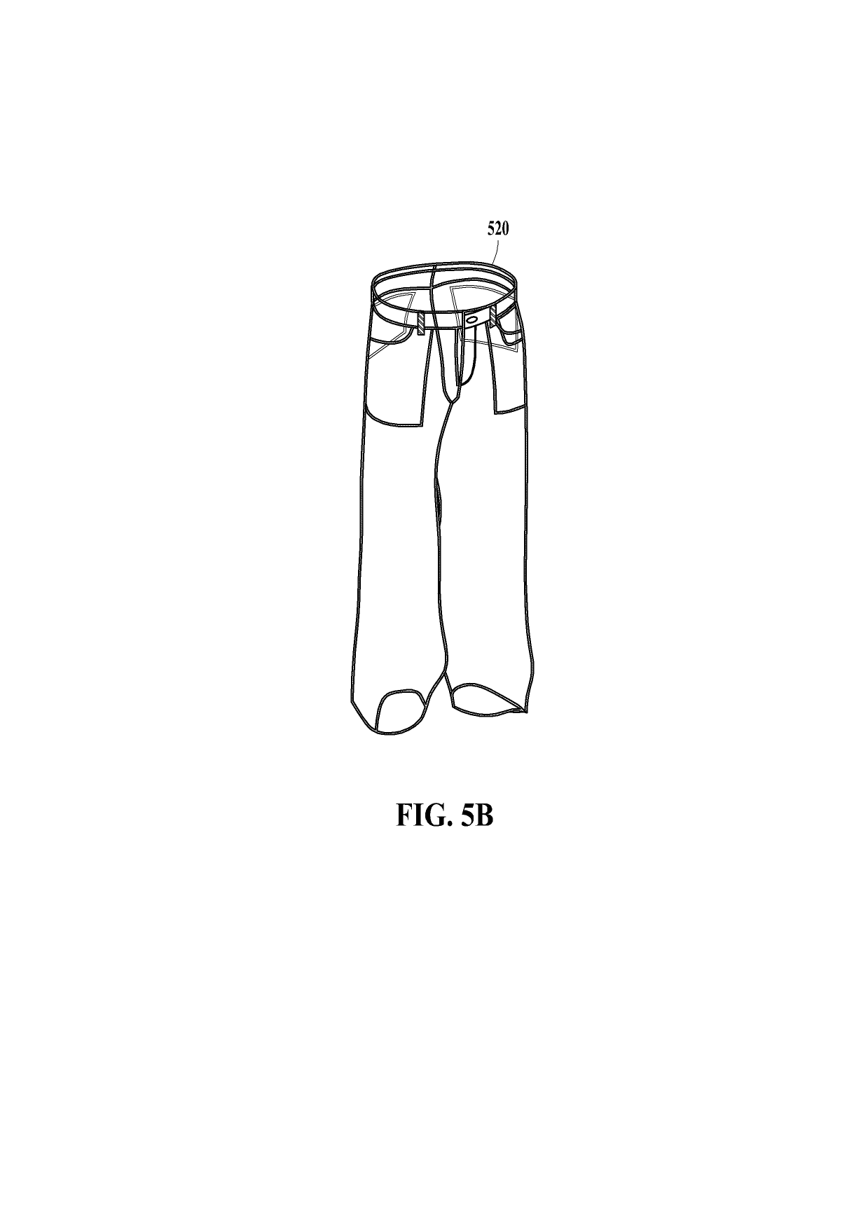

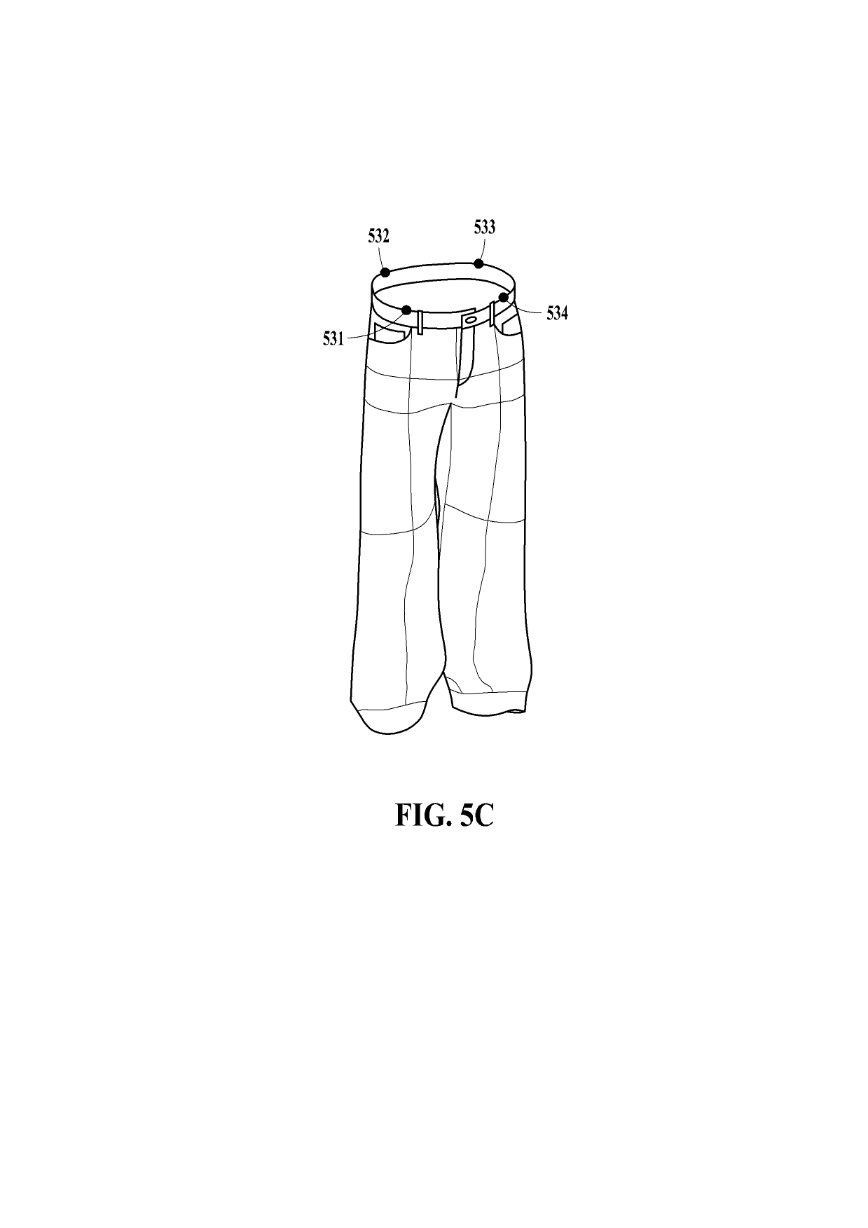

FIGS. 5A to 5C are diagrams illustrating extracting of feature points of a lower garment, according to an embodiment.

Referring to FIG. 5A, a vertex set including a plurality of vertices smoothly connected to each other may be determined. The vertices within the vertex set may be connected to form a line. In other words, the vertex set may correspond to a line.

The vertex set may initially include two vertices, including a first vertex 511 and a second vertex 512. The line connecting the vertices within the vertex set may be referred to as a line corresponding to the vertex set. Since an initial vertex set includes the first vertex 511 and the second vertex 512, a first line 513 connecting the first vertex 511 to the second vertex 512 may be the line corresponding to the vertex set.

The vertex set may be expanded by adding vertices that are smoothly connected to the line corresponding to the vertex set. When an angle formed by a second line 515 connecting the first vertex 511, which is an endpoint of the first line 513 corresponding to the vertex set, to a third vertex 514, which is not included in the vertex set, with the first line 513 corresponding to the vertex set is less than (or equal to or less than) a threshold value, the third vertex 514 may be determined to be a vertex that is smoothly connected to the line corresponding to the vertex set. The angle formed by the first line 513 with the second line 515 may correspond to an angle between a vector in a direction from the second vertex 512 to the first vertex 511 and a vector in a direction from the first vertex 511 to the third vertex 514. When the angle formed by the second line 515 with the first line 513 is less than the threshold value, the third vertex 514 may be included in the vertex set. The line corresponding to the vertex set may be extended to a line including the first line 513 and the second line 515. Furthermore, when an angle formed by a third line 517 connecting the first vertex 511, which is the endpoint of the first line 513, to a fourth vertex 516, which is not included in the vertex set, with the first line 513 corresponding to the vertex set is greater than or equal to (or greater than) the threshold value, the fourth vertex 516 may be determined to be a vertex that is not smoothly connected to the line corresponding to the vertex set. When the angle formed by the third line 517 with the first line 513 is greater than or equal to the threshold value, the fourth vertex 516 may not be included in the vertex set.

A plurality of vertex sets may be determined. For example, referring to FIG. 5B, a plurality of lines connecting vertices determined to belong to the same vertex set may be extracted from a garment. Among the lines extracted from the garment, a line closest to a waist position of an avatar may be determined to be a waistline of the garment. The line closest to the waist position of the avatar may be determined based on a simulation result for the garment on the avatar.

For example, when the simulation result for the garment on the avatar is as shown in FIG. 4C, a first line 520 is positioned closest to the waistline of the avatar and thus may be determined as the waistline.

For example, referring to FIG. 5C, four vertices including a first vertex 531, a second vertex 532, a third vertex 533, and a fourth vertex 534 on the waistline of the garment may be extracted as feature points of the garment to be arranged at feature points corresponding to clip portions of the hanger. For example, by solving an elliptic equation corresponding to the waistline, vertices to be positioned at feature points extracted from the hanger may be extracted as the feature points of the garment. For example, when the waistline extracted from the garment is a closed shape, by adding a distance of adjacent vertices from a specific vertex on the waistline, vertices positioned at a distance corresponding to a distance between the clip portions may be extracted as the feature points of the garment. For example, a distance from the first vertex 531 to the second vertex 532 may be calculated by adding a distance of adjacent vertices from the first vertex 531. When the distance between the first vertex 531 and the second vertex 532 is close to the distance between the clip portions, the first vertex 531 and the second vertex 532 may be extracted as the feature points of the garment.

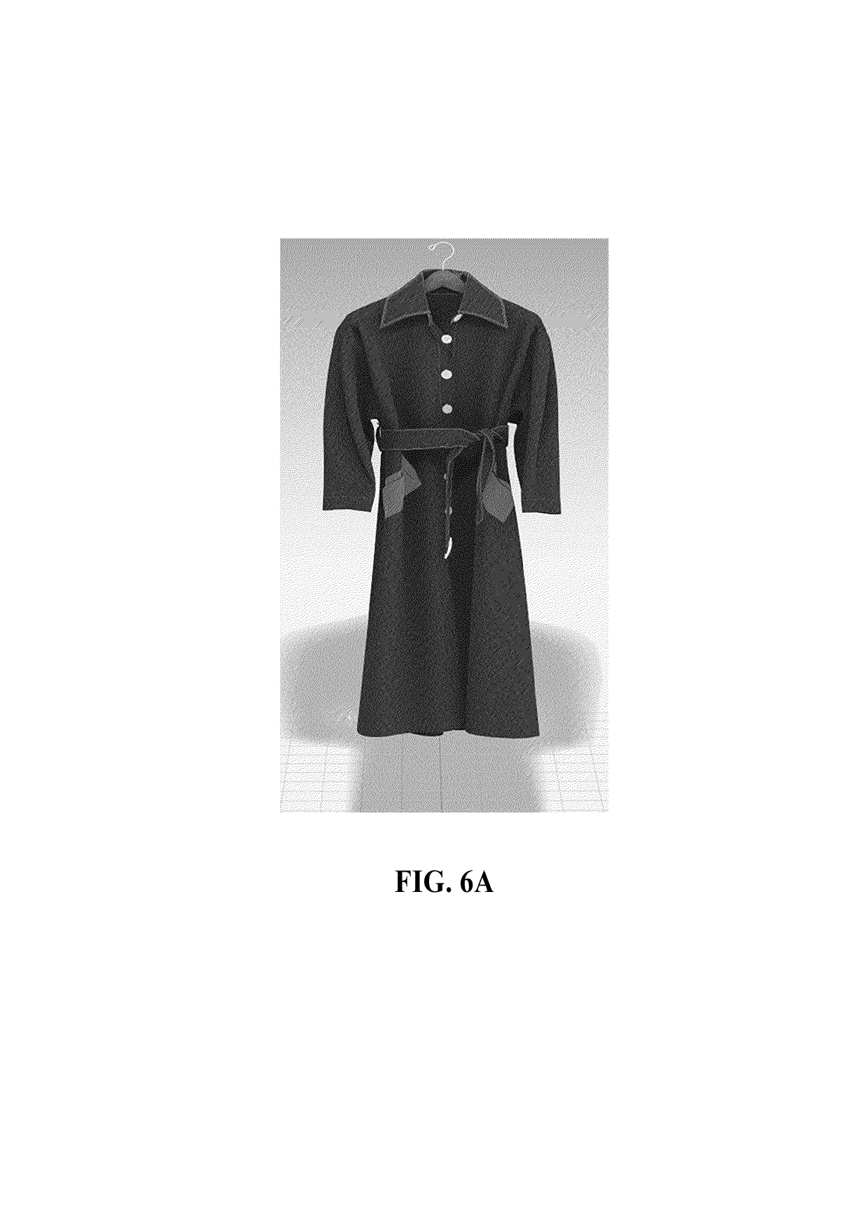

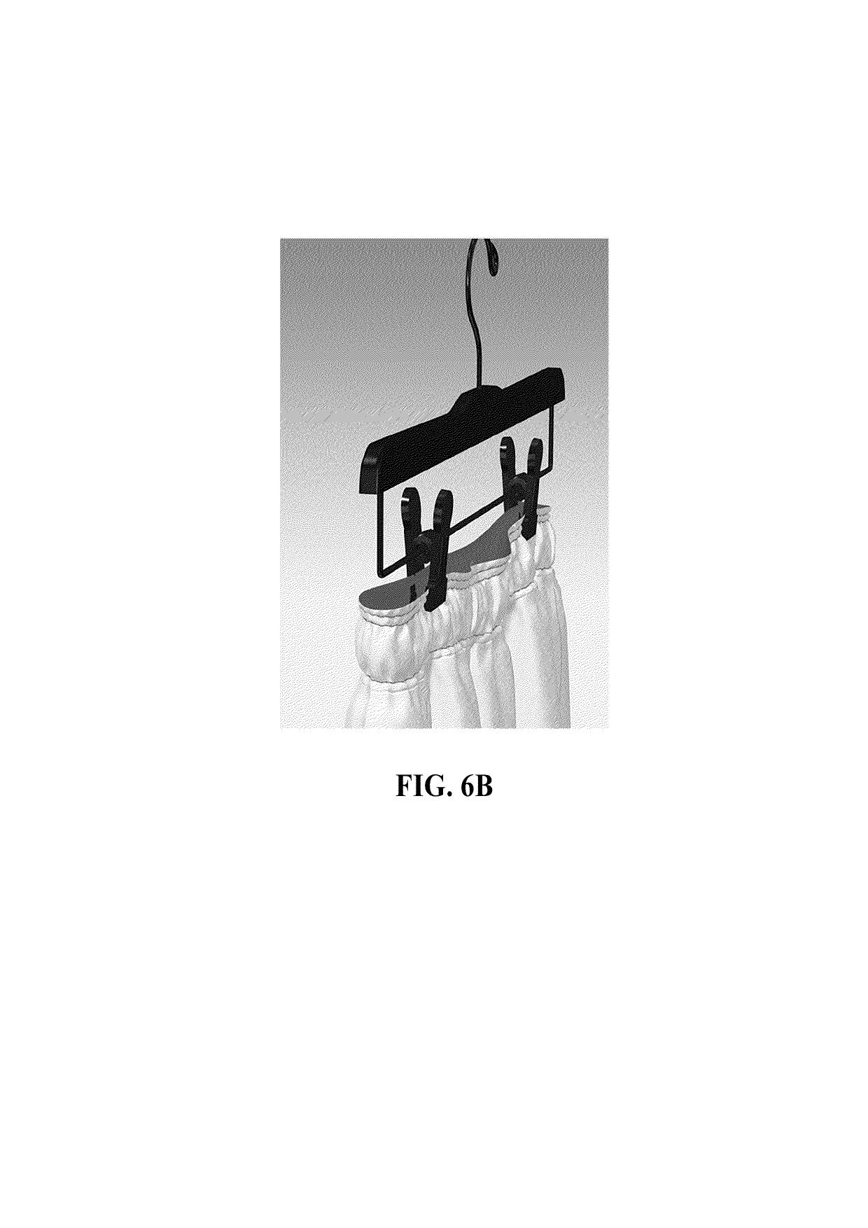

FIGS. 6A and 6B are diagrams illustrating simulation results of draping a garment on a hanger, according to an embodiment.

Referring to FIG. 6A, a shape of the garment hung on the hanger may be output from information about the shape of the garment.

As described above, feature points corresponding to a shoulder area may be extracted from each of the hanger and the garment. An initial arrangement of the hanger and the garment may be determined so that the feature points extracted from the garment are positioned at the feature points extracted from the hanger. From the initial arrangement of the hanger and the garment, a simulation of draping the garment may be performed to generate the information about the shape of the garment hung on the hanger, reflecting the laws of physics.

From the information about the shape of the garment hung on the hanger, the shape of the garment hung on the hanger may be visually output. By performing the simulation of draping the garment, the area of the garment positioned at the shoulder area of the hanger may be output as the shape of the garment hanging on the shoulder area of the hanger. By performing the simulation of draping the garment, an area of the garment that is not hung on the hanger may be output as a shape reflecting the influence of gravity.

Referring to FIG. 6B, the shape of the garment hung on the hanger may be output from the information about the shape of the garment hung on the hanger.

As described above, the feature points corresponding to clips may be extracted from the hanger and the feature points corresponding to a waistline may be extracted from the garment. The initial arrangement of the hanger and the garment may be determined so that the feature points extracted from the garment are positioned at the feature points extracted from the hanger. In the initial arrangement of the hanger and the garment, the simulation of draping the garment may be performed to generate the information about the shape of the garment hung on the hanger, reflecting the laws of physics.

A position constraint may be set on the feature points of the garment to simulate the shape of the garment being held by the clips. For example, the position constraint for the feature point corresponding to a first clip (e.g., a left clip) of the hanger may be set on a first feature point and a second feature point of the garment shown in FIG. 5C. In other words, when the simulation of draping the garment on the hanger is performed, the positions of the first and second feature points of the garment may be fixed to the position of the feature point corresponding to the first clip (e.g., the left clip). For example, the position constraint for the feature point corresponding to a second clip (e.g., a right clip) of the hanger may be set on a third feature point and a fourth feature point of the garment shown in FIG. 5C. In other words, when the simulation of draping the garment on the hanger is performed, the positions of the third and fourth feature points of the garment may be fixed to the position of the feature point corresponding to the second clip (e.g., the right clip) of the hanger. By setting the position constraint, the information about the shape of the garment held on the clips of the hanger may be generated. For example, the position of the position constraint may be set to an inner portion of the clips.

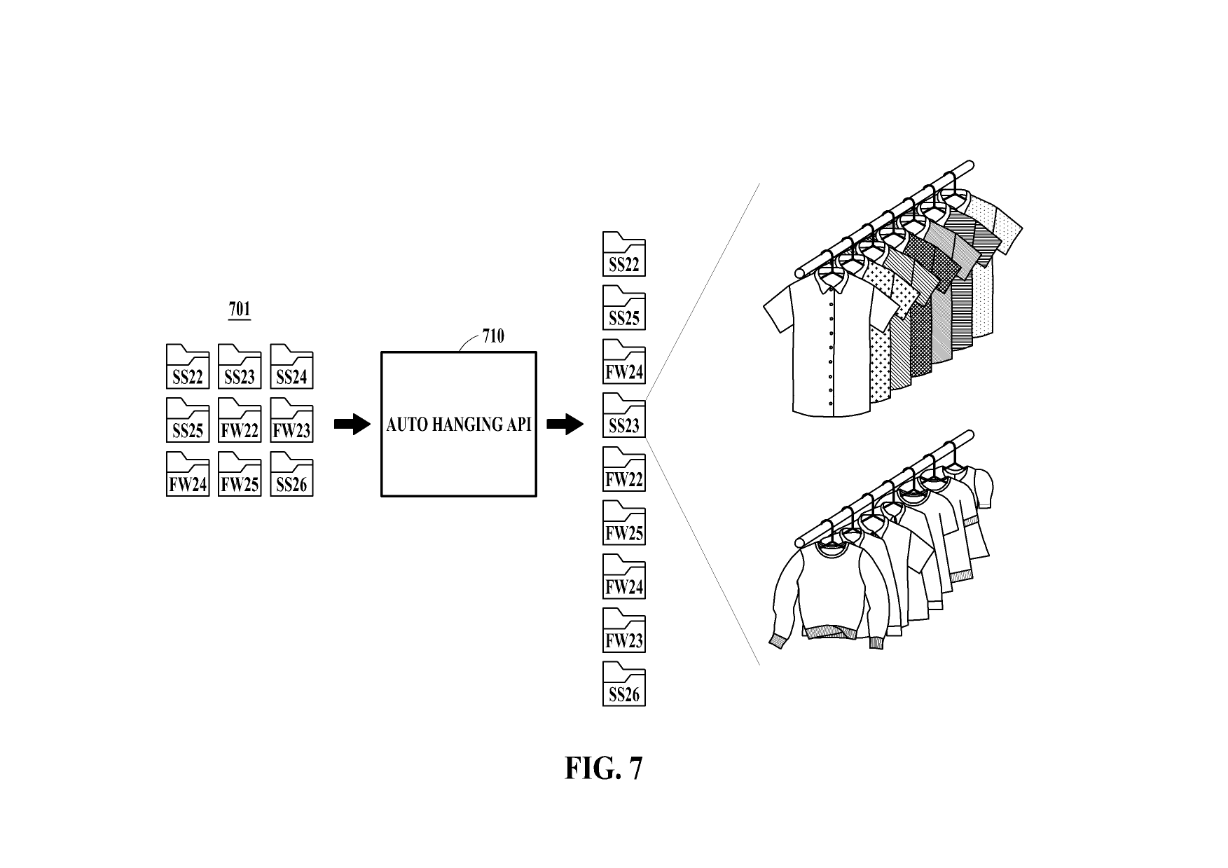

FIG. 7 is a diagram illustrating an auto-hanging simulation system according to an embodiment.

Referring to FIG. 7, according to an embodiment, a method of simulating hanging of virtual garments may be provided through an auto-hanging application programming interface (API) 710.

A terminal (e.g., a personal computer (PC), a tablet, a mobile phone, a wearable device, etc.) of a user may call the auto-hanging API 710 to transmit one or more garment files 701 to a server. The garment files 701 may be files storing information about a 3D shape of a garment. For example, the garment files 701 may include files storing mesh information. The server performing the method of simulating hanging of virtual garments may receive the garment files 701 input by the user via the auto-hanging API 710. The server performing the method of simulating hanging of virtual garments may be referred to simply as the server hereinafter.

The server may perform the method of simulating hanging of virtual garments on the garment files 701 input to generate information about the shape of the garments hung on hangers. The information about the shape of a garment hung on a hanger may include information about the shape of the garment hung on the hanger, which corresponds to an input garment file. For example, the server may generate information about the shape of each virtual garment hung on a hanger, which corresponds to a plurality of garment files.

The server may transmit the information about the shape of the garment hung on the hanger to the terminal of the user via the auto-hanging API 710. The terminal of the user may receive the information about the shape of the garment hung on the hanger. Based on the information about the shape of the garment hung on the hanger, the terminal of the user may output the shape of the garment hung on the hanger.

For example, the information about the shape of the garment hung on the hanger may be utilized to implement a virtual visual space, such as a virtual closet or showroom.

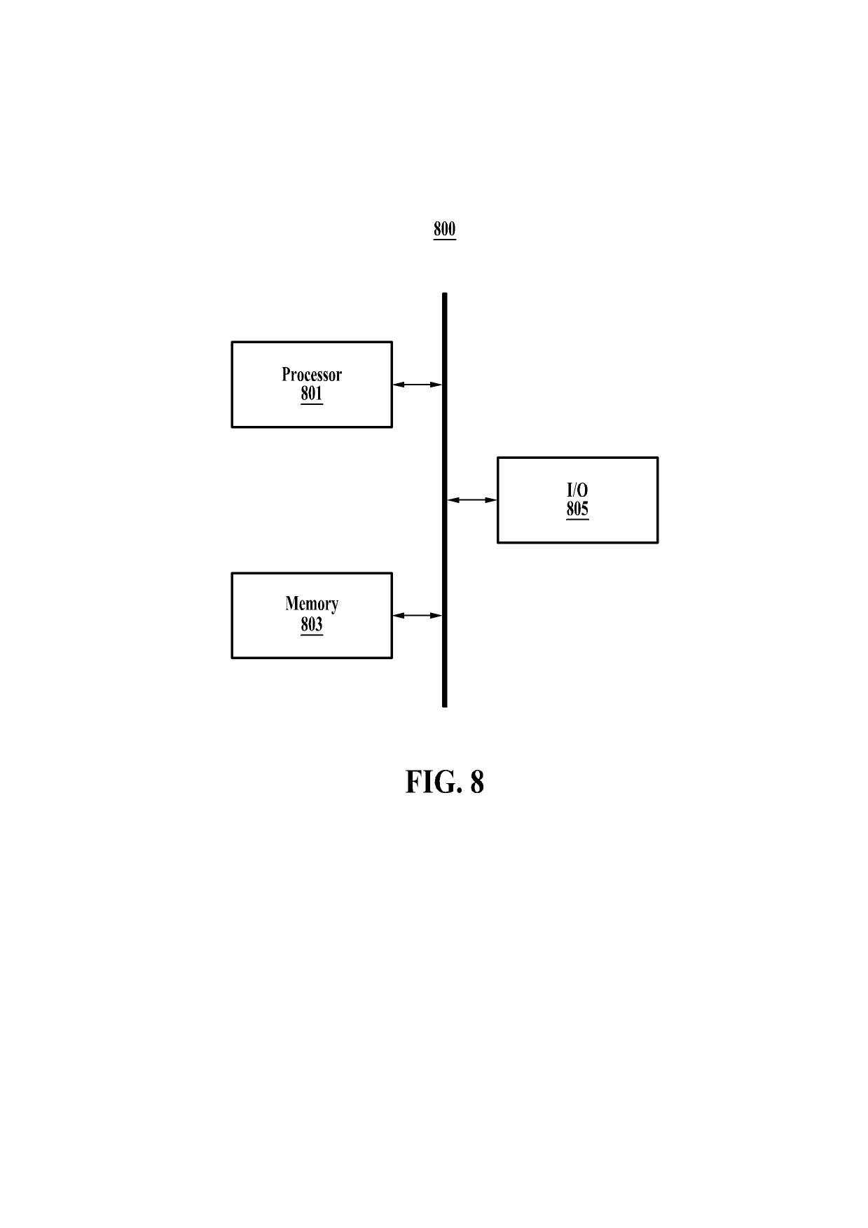

FIG. 8 a diagram illustrating an example of a configuration of a device according to an embodiment.

Referring to FIG. 8, according to an embodiment, an electronic device 800 may be an electronic device including a processor 801, a memory 803, and an input/output (I/O) device 805. The device 800 according to an embodiment may include an apparatus for performing the method of simulating hanging of a virtual garment described above with reference to FIGS. 1 to 7. For example, the device 800 may include at least one of a user terminal (e.g., a PC, a tablet, a mobile phone, a wearable device, etc.) or a server.

The device 800 according to an embodiment may include one or more processors 801. The one or more processors 801 may alone or jointly perform at least one operation included in the method of simulating hanging of a virtual garment described above with reference to FIGS. 1 to 7. For example, the processor 801 may perform at least one of determining a hanging mode corresponding to a hanger based on a topology analysis result of the hanger, extracting a feature point of the hanger and a feature point of a garment to be hung on the hanger based on the hanging mode, determining an initial arrangement of the hanger and the garment based on the feature point of the hanger and the feature point of the garment, and generating information about a shape of the garment hung on the hanger based on a simulation of draping the garment on the hanger in the initial arrangement.

For example, the processor 801 may perform at least one of obtaining the hanging mode of the hanger, arranging a target garment on the hanger based on the hanging mode with respect to a first feature area of the hanger, and hanging the target garment on the hanger by performing the simulation.

The memory 803 according to an embodiment may be a volatile memory or a non-volatile memory. The memory 803 may store data related to the method of simulating hanging of a virtual garment described above with reference to FIGS. 1 to 7. For example, the memory 803 may store data generated in a process of performing the method of simulating hanging of a virtual garment or data necessary for performing the method of simulating hanging of a virtual garment.

According to an embodiment, the memory 803 may not be a component of the device 800 but may be included in an external device accessible from the device 800. In this case, the device 800 may receive the data stored in the memory 803 included in the external device via a communication device and may transmit the data to be stored in the memory 803.

According to an embodiment, the memory 803 may store a program implementing the method of simulating hanging of a virtual garment described above with reference to FIGS. 1 to 7. The processor 801 may execute the program stored in the memory 803 and may control the device 800. Code of the program executed by the processor 801 may be stored in the memory 803.

For example, the memory 803 may store instruction(s). The instruction(s) stored in the memory 803, when executed alone or jointly by the processor 801, may cause the device 800 to perform determining a hanging mode corresponding to a hanger based on a topology analysis result of the hanger, extracting a feature point of the hanger and a feature point of a garment to be hung on the hanger based on the hanging mode, determining an initial arrangement of the hanger and the garment based on the feature point of the hanger and the feature point of the garment, and generating information about a shape of the garment hung on the hanger based on a simulation of draping the garment on the hanger in the initial arrangement.

The instruction(s) stored in the memory 803, when executed alone or jointly by the processor 801, may cause the device 800 to perform obtaining the hanging mode of the hanger, arranging a target garment on the hanger based on the hanging mode with respect to a first feature area of the hanger, and hanging the target garment on the hanger by performing the simulation.

The I/O device 805 according to an embodiment may include an input device and an output device. User input for determining a measurement point may be received through the I/O device 805, and a measurement distance may be output.

The device 800 according to an embodiment may further include other components not shown. For example, the device 800 may further include a communication device for communicating with other devices (e.g., a server, a terminal, a network, etc.). For example, the device 800 may further include other components such as a transceiver, various sensors, a database, etc.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and multiple modes of processing elements. For example, a processing device may include multiple processors or a processor and a controller. In addition, different processing configurations are possible, such as parallel processors.

The software may include a computer program, a piece of code, an instruction, or combinations thereof, to independently or uniformly instruct or configure the processing device to operate as desired. Software and data may be stored in any mode of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

What is claimed is:

1. A method of simulating hanging of a virtual garment, the method comprising:
receiving a hanging mode of a hanger;
arranging a target garment of the hanger based on the hanging mode with respect to a first feature area of the hanger, the first feature area comprising at least a portion of the hanger; and
simulating hanging of the target garment on the hanger.

2. The method of claim 1, wherein the at least a portion of the hanger is determined based on the hanging mode.

3. The method of claim 1, wherein the first feature area comprises a shoulder area of the hanger, a clip area of the hanger, or an intersection area of the hanger, and
the intersection area comprises an area in which the shoulder area is connected to the clip area.

4. The method of claim 1, wherein the first feature area excludes a hook area of the hanger.

5. The method of claim 1, wherein the arranging of the target garment of the hanger based on the hanging mode with respect to the first feature area of the hanger comprises arranging a second feature area of the target garment based on the hanging mode with respect to the first feature area of the hanger, and
the second feature area comprises at least a portion of the target garment.

6. The method of claim 5, wherein a midpoint of the first feature area and a midpoint of the second feature area are aligned along an axis in a three-dimensional (3D) space in which the hanger and the target garment are arranged.

7. The method of claim 6, wherein the second feature area comprises a shoulder area of the target garment, a waist area of the target garment, or a neck area of the target garment.

8. The method of claim 1, wherein a front direction vector of the target garment is arranged parallel to a front direction vector of the hanger.

9. A non-transitory computer-readable storage medium storing instructions thereon, the instructions, when executed by a processor, cause one or more processors to:
receive a hanging mode of a hanger;
arrange a target garment of the hanger based on the hanging mode with respect to a first feature area of the hanger, the first feature area comprising at least a portion of the hanger; and
simulate hanging of the target garment on the hanger.

10. An electronic device comprising:
at least one processor comprising processing circuitry; and
a memory configured to store instructions, the instructions, when executed by the at least one processor, cause the at least one processor to:
receive a hanging mode of a hanger;
arrange a target garment of the hanger based on the hanging mode with respect to a first feature area of the hanger, the first feature area comprising at least a portion of the hanger; and
simulate hanging of the target garment on the hanger.
